(19) United States
(12) Patent Application Publication
(10) Pub. No.: US 2026/0245573 A1
(43) Pub. Date: Aug. 20, 2026

(54) Audio Enhancement for Earphones

(71) Applicant: Anker Innovations Technology Co., Ltd., Changsha (CN)

(72) Inventors: Xu Zhang, Shenzhen (CN); Jianqiang Wei, Shenzhen (CN); Lei Li, Shenzhen (CN); Shikun Zhu, Shenzhen (CN); Xiangyu Deng, Shenzhen (CN); Bo Fang, Shenzhen (CN)

(21) Appl. No.: 19/372,459

(22) Filed: Oct. 29, 2025

(30) Foreign Application Priority Data
Oct. 30, 2024 (CN) 202411535508.1

(51) Int. Cl. G10L 21/0232; G10L 21/0216; G10L 25/30

(52) U.S. Cl. CPC G10L 21/0232; G10L 25/30; G10L 2021/02165

(57) ABSTRACT

The present application describes an audio enhancement method and apparatus, and an earphone system. The audio enhancement method comprises: acquiring an air conduction audio signal and a bone conduction audio signal; and determining a first audio feature of the air conduction audio signal and a second audio feature of the bone conduction audio signal. The method further comprises performing feature extraction on the bone conduction audio signal using a feature extraction model to obtain a voiceprint feature of the bone conduction audio signal; and inputting the voiceprint feature of the bone conduction audio signal, the first audio feature, and the second audio feature into an amplitude prediction model to obtain a predicted amplitude. The method further comprises enhancing audio based on the predicted amplitude to obtain a target audio signal.

### CROSS-REFERENCE TO RELATED APPLICATION

The present application claims priority to CN Application No. 202411535508.1, filed on Oct. 30, 2024. The above application is incorporated herein in its entirety.

### TECHNICAL FIELD

The present application relates to the technical field of audio processing, and specifically, to an audio enhancement method and apparatus, and an earphone.

### BACKGROUND

This section is intended to provide a background or context for the present invention set forth in claims and detailed description. The description in this section should not be admitted as the prior art.

The popularity of mobile communication devices allows users to make calls or record audio virtually anytime and anywhere. However, ambient noise and interfering human voice during these activities degrade the clarity of audio signals collected by the devices, leading to poor call or recording quality. Therefore, noise reduction is required to reduce or cancel ambient noise or interference with calls or recording, thereby improving audio quality.

### SUMMARY

In view of the above technical problems, it is desirable to provide an audio enhancement method and apparatus capable of improving audio quality, and related earphones.

In a first aspect, the present application provides an audio enhancement method, comprising: acquiring an air conduction audio signal and a bone conduction audio signal; determining a first audio feature of the air conduction audio signal and a second audio feature of the bone conduction audio signal; performing feature extraction on the bone conduction audio signal using a feature extraction model to obtain a voiceprint feature of the bone conduction audio signal; inputting the voiceprint feature of the bone conduction audio signal, the first audio feature, and the second audio feature into a amplitude prediction model to obtain a predicted amplitude; and obtaining a target audio signal based on the predicted amplitude.

In a second aspect, the present application provides an audio enhancement apparatus, comprising: a first acquisition module, configured to acquire an air conduction audio signal and a bone conduction audio signal; a second acquisition module, configured to determine a first audio feature of the air conduction audio signal and a second audio feature of the bone conduction audio signal; a feature extraction module, configured to perform feature extraction on the bone conduction audio signal using a feature extraction model to obtain a voiceprint feature of the bone conduction audio signal; an amplitude prediction module, configured to input the voiceprint feature of the bone conduction audio signal, the first audio feature, and the second audio feature into an amplitude prediction model to obtain a predicted amplitude; and an audio enhancement module, configured to obtain a target audio signal based on the predicted amplitude.

In a third aspect, the present application further provides an earphone system, comprising an air conduction microphone, a bone conduction microphone, a memory, and one or more processors. The air conduction microphone is configured to collect an air conduction signal, and the bone conduction microphone is configured to collect a bone conduction signal. The memory storing a computer program, where the one or more processors, when executing the computer program, implement the following steps: receiving the air conduction audio signal and the bone conduction audio signal; determining a first audio feature of the air conduction audio signal and a second audio feature of the bone conduction audio signal; performing feature extraction on the bone conduction audio signal using a feature extraction model to obtain a voiceprint feature of the bone conduction audio signal; inputting the voiceprint feature of the bone conduction audio signal, the first audio feature, and the second audio feature into an amplitude prediction model to obtain a predicted amplitude; and obtaining a target audio signal based on the predicted amplitude.

According to the audio enhancement method and apparatus and the earphone system, the air conduction audio signal and the bone conduction audio signal are acquired; the first audio feature of the air conduction audio signal and the second audio feature of the bone conduction audio signal are determined; feature extraction is performed on the bone conduction audio signal using a feature extraction model to obtain the voiceprint feature of the bone conduction audio signal; the voiceprint feature of the bone conduction audio signal, the first audio feature, and the second audio feature are input into an amplitude prediction model to obtain the predicted amplitude; and the target audio signal is obtained based on the predicted amplitude.

The audio signal collected through air conduction has a wide frequency range, while the audio signal collected through bone conduction is almost not interfered by environmental noise. In the present application, the primary model is utilized to extract the voiceprint feature from the bone conduction audio signal, so the extracted voiceprint feature continues the advantage of low bone conduction noise and can assist in noise reduction. The voiceprint feature and the audio features of the air conduction audio signal and the bone conduction audio signal are fused in the pre-trained secondary model to obtain the predicted amplitude, where the predicted amplitude may be used to generate an enhanced audio signal. The dual model mechanism of the present application integrates the advantages of bone conduction and air conduction, whereby the obtained target audio signal does not lose the frequency band and noise reduction is achieved, thereby improving audio quality.

### BRIEF DESCRIPTION OF THE DRAWINGS

In order to illustrate technical solutions in examples of the present application or the related art more clearly, the accompanying drawings required in the description of the examples of the present application or the related art will be briefly introduced below. Apparently, the drawings described below show merely some examples of the present application. A person of ordinary skill in the art may also derive other related drawings based on these drawings without any creative efforts.

FIG. 1 is an application environment diagram of an audio enhancement method and a fusion training method in one example;

FIG. 2 is a schematic flowchart of an audio enhancement method in one example;

FIG. 3 is a schematic flowchart of a fusion training method in one example;

FIG. 4 is a schematic flowchart of an audio enhancement method and a fusion training method in another example;

FIG. 5 is a structural block diagram of an audio enhancement apparatus in one example;

FIG. 6 is another structural block diagram of an audio enhancement apparatus in one example;

FIG. 7 is a structural block diagram of a fusion training apparatus in one example;

FIG. 8 is an internal structural diagram of a computer device in one example; and

FIG. 9 is an internal structural diagram of a computer device in another example.

### DETAILED DESCRIPTION

In order to make the objectives, technical solutions, and advantages of the present application clearer, the present application will be further described in detail below in conjunction with the accompanying drawings and examples. It should be understood that the specific examples described herein are merely used to explain the present application and are not intended to be used in the description of the present application, and examples are described only for the purpose of distinguishing technical features and should not be understood as indicating or implying relative importance or implicitly indicating the quantity of indicated technical features or implicitly indicating the sequence of indicated technical features.

In the description of the present application, unless otherwise explicitly limited, the terms, such as arranged, installed, and connected, should be understood in a broad sense. A person skilled in the art may reasonably determine specific meanings of the terms in the present application based on the specific contents of technical solutions.

Audio enhancement, also known as audio noise reduction, includes a process of removing noise components from audio signals and preserving desired audio signals. Methods for audio enhancement may include conventional audio enhancement algorithms and neural network-based audio enhancement. Among them, the neural network-based audio enhancement has predominant performance, especially for undesired types of noise such as sudden noise. Due to the complexity of noise damage, the neural network-based audio enhancement exhibits significant advantages in low signal-to-noise ratio, non-stationary noise, and other environments.

In the related field of earphone audio enhancement, the neural network-based audio enhancement technology combines conventional beam-forming technology with single-channel audio enhancement technology to improve call quality and comprehensibility. Such a combination can achieve good effects in some scenarios, but the effects may deteriorate in extremely low signal-to-noise ratios and the presence of interfering human voice.

In some cases, multi-microphone audio enhancement technology for earphones may be used to deal with vocal interference in audio, but its effect may be still poor in low signal-to-noise ratio scenarios. Moreover, the multi-microphone audio enhancement technology cannot be applied to situations of only a single microphone.

With the development of video processing units (VPU) (e.g., in bone conduction microphones), the high signal-to-noise ratio of VPU signals at low frequencies (such as below 1 KHz) has greatly promoted the development of audio enhancement technology for wearable devices such as earphones. The audio enhancement based on VPU signals still has good effects in extremely low signal-to-noise ratio scenarios and scenarios with interfering human voice, and can ensure the quality of voice calls. By leveraging the high low-frequency signal-to-noise ratio of VPU signals, low-frequency VPU signals may be concatenated with high-frequency earphone talk signals, and then the concatenated signals are processed through a single-channel audio enhancement network. However, the simple concatenation of the VPU signals with the talk signals still presents some problems, such as: poor cancellation of interfering human voice, “frequency band interruption” that affects the auditory experience, and poor restoration of high-frequency components.

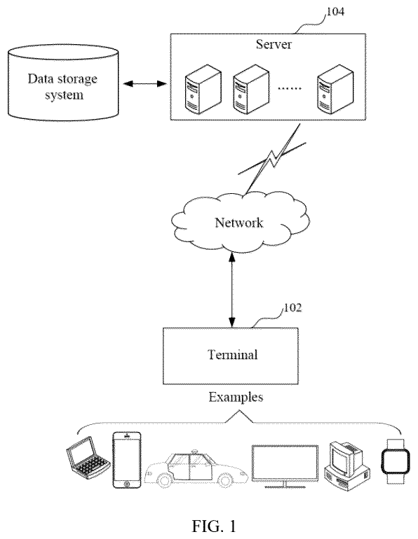

To solve the above problems, the present application describes an audio enhancement method and a fusion training method. FIG. 1 is an application environment diagram of an audio enhancement method and a fusion training method in one example. The audio enhancement method(s) and the fusion training method(s) provided in the present application may be applied to the application environment shown in FIG. 1. A terminal 102 communicates with a server 104 through a network. A data storage system may store data, and the server 104 can process the data. The data storage system may be integrated on the server 104, or placed on a cloud or another server.

Both the terminal 102 and the server 104 may be used separately to perform the audio enhancement method(s) and the fusion training method(s) provided in the present application.

For example, the terminal 102 acquires an air conduction audio signal sample and a bone conduction audio signal sample. The terminal 102 acquires a third audio feature of the air conduction audio signal sample and a fourth audio feature of the bone conduction audio signal sample. The terminal 102 uses the bone conduction audio signal sample as input data for a feature extraction model. The terminal 102 uses output of the feature extraction model, the third audio feature, and the fourth audio feature as input data for an amplitude prediction model, and uses an amplitude of the air conduction audio signal sample as target output of the amplitude prediction model, to perform fusion training on the feature extraction model and the amplitude prediction model to obtain a trained feature extraction model and a trained amplitude prediction model.

Additionally, for example, the terminal 102 acquires an air conduction audio signal and a bone conduction audio signal. The terminal 102 acquires a first audio feature of the air conduction audio signal and a second audio feature of the bone conduction audio signal. The terminal 102 performs feature extraction on the bone conduction audio signal through the trained feature extraction model to obtain a voiceprint feature of the bone conduction audio signal. The terminal 102 inputs the voiceprint feature of the bone conduction audio signal, the first audio feature, and the second audio feature into the trained amplitude prediction model to obtain a predicted amplitude. The terminal 102 obtains a target audio signal based on the predicted amplitude.

In addition, the terminal 102 and the server 104 may also collaborate to perform the audio enhancement method(s) and the fusion training method(s) provided in the present application.

For example, the server 104 acquires an air conduction audio signal sample and a bone conduction audio signal sample. The server 104 acquires a third audio feature of the air conduction audio signal sample and a fourth audio feature of the bone conduction audio signal sample. The server 104 uses the bone conduction audio signal sample as input data for a feature extraction model. The server 104 uses output of the feature extraction model, the third audio feature, and the fourth audio feature as input data for an amplitude prediction model, and uses an amplitude of the air conduction audio signal sample as target output of the amplitude prediction model, to perform fusion training on the feature extraction model and the amplitude prediction model to obtain a trained feature extraction model and a trained amplitude prediction model.

The server 104 provides an interface for the terminal to call (e.g., use) the models. The terminal 102 acquires an air conduction audio signal and a bone conduction audio signal. The terminal 102 acquires a first audio feature of the air conduction audio signal and a second audio feature of the bone conduction audio signal. The terminal 102 performs feature extraction on the bone conduction audio signal through the trained feature extraction model to obtain a voiceprint feature of the bone conduction audio signal. The terminal 102 inputs the voiceprint feature of the bone conduction audio signal, the first audio feature, and the second audio feature into the trained amplitude prediction model to obtain a predicted amplitude; and the terminal obtains a target audio signal based on the predicted amplitude.

For example, the terminal 102 acquires an air conduction audio signal sample and a bone conduction audio signal sample. The terminal 102 acquires a third audio feature of the air conduction audio signal sample and a fourth audio feature of the bone conduction audio signal sample. The terminal sends the bone conduction audio signal sample, the third audio feature, and the fourth audio feature to the server 104. The server 104 uses the bone conduction audio signal sample as input data for a feature extraction model, uses output of the feature extraction model, the third audio feature, and the fourth audio feature as input data for an amplitude prediction model, and uses an amplitude of the air conduction audio signal sample as target output of the amplitude prediction model, to perform fusion training on the feature extraction model and the amplitude prediction model to obtain a trained feature extraction model and a trained amplitude prediction model.

The terminal 102 acquires an air conduction audio signal and a bone conduction audio signal. The terminal 102 acquires a first audio feature of the air conduction audio signal and a second audio feature of the bone conduction audio signal. The terminal 102 sends the bone conduction audio signal, the first audio feature, and the second audio feature to the server. The terminal 102 performs feature extraction on the bone conduction audio signal through the trained feature extraction model to obtain a voiceprint feature of the bone conduction audio signal. The server 104 inputs the voiceprint feature of the bone conduction audio signal, the first audio feature, and the second audio feature into the trained amplitude prediction model to obtain a predicted amplitude. The server 104 obtains a target audio signal based on the predicted amplitude. The server 104 sends the target audio signal to the terminal.

The terminal 102 may be a smart phone, a tablet, a laptop, a desktop computer, a smart speaker, a smart watch, an Internet of things (IoT) device, or a portable wearable device. The IoT device may be a smart speaker, a smart television, a smart air conditioner, a smart vehicle device, a projection device, etc. The portable wearable device may be a smart watch, a smart wristband, a headset device, etc. The headset device may be a virtual reality (VR) device, an augmented reality (AR) device, smart glasses, etc.

The server 104 may be an independent physical server, a server cluster or distributed system composed of a plurality of physical servers, or a cloud server providing cloud computing services.

The terminal 102 and the server 104 may be connected in a communication manner via Bluetooth, a universal serial bus (USB), a network, etc., without limitation herein.

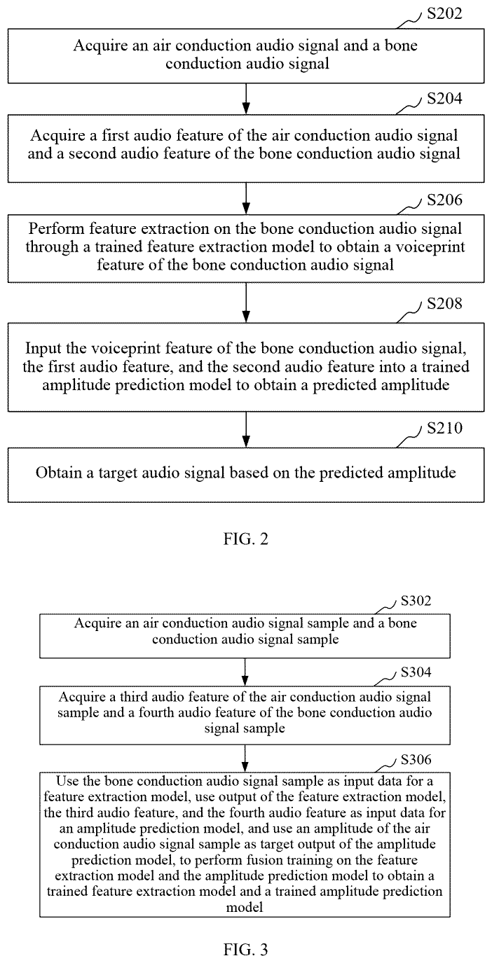

In an example, as shown in FIG. 2, an audio enhancement method is provided. The method is applied to the terminal in FIG. 1 as an example for explanation, and includes steps S202 to S210 below.
Step S202: Acquire an air conduction audio signal and a bone conduction audio signal.

The air conduction audio signal and the bone conduction audio signal may be acquired based on the same audio. The air conduction audio signal and the bone conduction audio signal of the same audio include the same or similar audio content, for example, they may be audio signals acquired for the same scenario in the same time period.

In an example, a computer device (e.g., the terminal 102) may be a wearable device. The wearable device can be earphones, earbuds, and/or headphones. An air conduction microphone and a bone conduction microphone may be configured in the wearable device. The bone conduction microphone is disposed at a wearing position of the wearable device and closely attached to a user. When the wearer produces a sound, the sound is transmitted through bone conduction to the bone conduction microphone, and the bone conduction microphone collects the sound as an original bone conduction signal.

In a scenario such as a voice call, the wearer of the wearable device produces a sound, and the wearable device collects a wearer's sound signal through the bone conduction microphone as an original bone conduction signal, and collects the wearer's sound signal through the air conduction microphone as an original air conduction signal. For example, the air conduction microphone may simultaneously collect a wearer's sound signal and an environmental sound signal of an environment where the wearer is located, and combine the collected wearer's sound signal and environmental sound signal as original air conduction signals.

The air conduction audio signal may be an original air conduction signal collected by the air conduction microphone, or an audio signal obtained by pre-processing the original air conduction signal collected by the air conduction microphone. The bone conduction audio signal may be an original bone conduction signal collected by the bone conduction microphone, or an audio signal obtained by pre-processing the original bone conduction signal collected by the bone conduction microphone. The pre-processing may include, but is not limited to, feature transformation, signal segmentation, signal alignment, etc.

For example, an original air conduction signal is collected through the air conduction microphone, feature transformation is performed on the original air conduction signal to obtain a frequency domain signal of the original air conduction signal, and an air conduction audio signal is obtained based on the original air conduction signal and the frequency domain signal of the original air conduction signal. In addition, an original bone conduction signal is collected through the bone conduction microphone, feature transformation is performed on the original bone conduction signal to obtain a frequency domain signal of the original bone conduction signal, and a bone conduction audio signal is obtained based on the original bone conduction signal and the frequency domain signal of the original bone conduction signal. The feature transformation may transform a signal from a time domain to a frequency domain, including but not limited to short-time Fourier transformation, wavelet transformation, continuous wavelet transformation, S transformation, etc.

The present application does not limit the quantity of the air conduction microphone and the bone conduction microphone. One or more original air conduction signals and original bone conduction signals may be acquired, corresponding to one or more air conduction audio signals and bone conduction audio signals. For example, a plurality of air conduction microphones and one bone conduction microphone may be configured in a device, a plurality of original air conduction signals are collected through the plurality of air conduction microphones, the plurality of original air conduction signals are pre-processed to obtain a plurality of air conduction audio signals, one original bone conduction signal is collected through the bone conduction microphone, and the original bone conduction signal is pre-processed to obtain a bone conduction audio signals.
Step S204: Acquire a first audio feature of the air conduction audio signal and a second audio feature of the bone conduction audio signal.

The audio feature includes audio information and can reflect the characteristics of the audio signal. The audio feature of the audio signal may include amplitude and phase, and may also include other features that can reflect the characteristics of the audio signal, such as duration and source.

It should be noted that the “first” and “second” in the first audio feature and the second audio feature are merely for distinguishing the sources of the audio features, that is, from the air conduction audio signal and the bone conduction audio signal, respectively. The first audio feature and the second audio feature may be of the same type of audio signals obtained by processing the air conduction audio signal and the bone conduction audio signal in the same way.
Step S206: Perform feature extraction on the bone conduction audio signal through a trained feature extraction model to obtain a voiceprint feature of the bone conduction audio signal.

The bone conduction audio signal can be directly or indirectly derived from an original bone conduction signal collected by the bone conduction microphone. Due to the sound propagation mode of bone conduction, the original bone conduction signal includes little noise, resulting in little interference in the corresponding bone conduction audio signal. To achieve the maximum noise reduction effect, feature processing may be first performed on the bone conduction audio signal to obtain the voiceprint feature of the bone conduction audio signal, where the voiceprint feature may assist in noise reduction during subsequent feature fusion.

To implement the feature extraction on the bone conduction audio signal, a feature extraction model may be pre-trained in the present application. The feature extraction model may be constructed based on a neural network. The neural network may include a plurality of layers, such as an input layer, an output layer, a hidden layer, and a normalization layer, and the layers are interconnected through weights and activation functions. The feature extraction model is trained with a bone conduction audio signal sample and a corresponding voiceprint feature label as a training set, so that the feature extraction model learns how to extract the voiceprint feature of the bone conduction audio signal. The trained feature extraction model receives the bone conduction audio signal as input data, and performs feature extraction on the bone conduction audio signal to obtain the voiceprint feature of the bone conduction audio signal.

In an example, when the neural network is a convolutional neural network, the feature extraction model may further include a convolutional layer. For example, the convolutional layer convolves received data to extract the voiceprint feature of the bone conduction audio signal.
Step S208: Input the voiceprint feature of the bone conduction audio signal, the first audio feature, and the second audio feature into a trained amplitude prediction model to obtain a predicted amplitude.

In addition to the feature extraction model, an amplitude prediction model may be pre-trained in the present application. The amplitude prediction model may be used to obtain the predicted amplitude based on the input voiceprint feature of the bone conduction audio signal and the input audio features of the bone conduction audio signal and the air conduction audio signal. The predicted amplitude includes amplitude information of a desired enhancement result of a collected sound.

To obtain the predicted amplitude based on input data such as the voiceprint feature of the bone conduction audio signal and the audio features of the bone conduction audio signal and the air conduction audio signal, the amplitude prediction model may be pre-constructed based on a neural network, and the amplitude prediction model may be trained by the learning ability of the neural network to learn a corresponding relationship between these input data and the predicted amplitude.

The amplitude prediction model may include a plurality of layers, such as an input layer, an output layer, a hidden layer, and a normalization layer, and the layers are interconnected through weights and activation functions. The amplitude prediction model may be trained with a voiceprint feature of a bone conduction audio signal sample and audio features of the bone conduction audio signal sample and an air conduction audio signal sample as input data, and with an amplitude of the bone conduction audio signal sample or air conduction audio signal sample as target data. When preset training end conditions are satisfied, the training ends, and the trained amplitude prediction model is obtained.

The predicted amplitude may be obtained by inputting the voiceprint feature of the bone conduction audio signal, the first audio feature, and the second audio feature into the trained amplitude prediction model. The predicted amplitude varies based on different target data for training the amplitude prediction model. By selecting different target data during training, the amplitude prediction model may output a specific predicted amplitude for enhancing the bone conduction audio signal or enhancing the air conduction audio signal.

For example, if the amplitude of the bone conduction audio signal sample is used as target data, the amplitude prediction model learns a relationship between the input data and the amplitude of the bone conduction audio signal sample during training. After the training ends to obtain the trained amplitude prediction model, the voiceprint feature of the bone conduction audio signal, the first audio feature, and the second audio feature are input into the trained amplitude prediction model to obtain the predicted amplitude used for enhancing the bone conduction audio signal.

If the amplitude of the air conduction audio signal sample is used as target data, the amplitude prediction model learns a relationship between the input data and the amplitude of the air conduction audio signal sample during training. After the training ends to obtain the trained amplitude prediction model, the voiceprint feature of the air conduction audio signal, the first audio feature, and the second audio feature are input into the trained amplitude prediction model to obtain the predicted amplitude used for enhancing the air conduction audio signal.
Step S210: Obtain a target audio signal based on the predicted amplitude.

In signal processing, amplitude and phase are two basic attributes that describe a signal wave. The amplitude refers to a maximum distance that the signal wave deviates from a reference value, and the phase refers to a position of the signal wave at a moment relative to a reference time point in the signal wave. A product of amplitude and phase is a negative representation of the signal wave. After the predicted amplitude is obtained, the predicted amplitude is multiplied by a specific phase to reconstruct a signal wave of the sound, whereby audio enhancement of the corresponding audio signal is implemented through reconstruction.

Based on audio enhancement requirements for different enhancement objects, the predicted amplitude may be multiplied by different phases to reconstruct signal waves of the enhancement objects as enhancement results for audio signals of the enhancement objects, where the enhancement results are target audio signals.

For example, the enhancement object may be a relevant audio signal of bone conduction, such as an original bone conduction signal or a bone conduction audio signal. In the training phase, the amplitude prediction model may be trained with the phase of the bone conduction audio signal sample as target data. When the target audio signal is obtained based on the predicted amplitude, the predicted amplitude may be multiplied by the phase of the bone conduction audio signal to obtain an enhancement result showing that the target audio signal is the relevant audio signal of bone conduction.

For example, the enhancement object may be a relevant audio signal of air conduction, such as an original air conduction signal or an air conduction audio signal. In the training phase, the amplitude prediction model may be trained with the phase of the air conduction audio signal sample as target data. When the target audio signal is obtained based on the predicted amplitude, the predicted amplitude may be multiplied by the phase of the air conduction audio signal to obtain an enhancement result showing that the target audio signal is the relevant audio signal of air conduction.

According to the foregoing audio enhancement method, the air conduction audio signal and the bone conduction audio signal are acquired, for example, by a computing device such as earphones. The earphones may comprise an air conduction microphone, and a bone conduction microphone. A first audio feature of the air conduction audio signal and a second audio feature of the bone conduction audio signal may be acquired. Feature extraction may be performed on the bone conduction audio signal through the trained feature extraction model to obtain the voiceprint feature of the bone conduction audio signal. The voiceprint feature of the bone conduction audio signal, the first audio feature, and the second audio feature may be input into the trained amplitude prediction model to obtain the predicted amplitude. The target audio signal may be obtained based on the predicted amplitude. The audio signal collected through air conduction has a wide frequency range, while the audio signal collected through bone conduction is almost not interfered by environmental noise. In the present application, the primary model may be utilized to extract the voiceprint feature from the bone conduction audio signal, so the extracted voiceprint feature continues the advantage of low bone conduction noise and can assist in noise reduction. The voiceprint feature and the audio features of the air conduction audio signal and the bone conduction audio signal may be fused in the pre-trained secondary model to obtain the predicted amplitude, where the predicted amplitude may be used to generate an enhanced audio signal. The dual model mechanism of the present application integrates the advantages of bone conduction and air conduction, whereby the obtained target audio signal does not lose the frequency band and noise reduction is achieved, thereby improving audio quality.

In one example, acquiring an air conduction audio signal and a bone conduction audio signal includes: collecting an original air conduction signal based on an air conduction microphone, and collecting an original bone conduction signal based on a bone conduction microphone; performing short-time Fourier transformation on the original air conduction signal to obtain a frequency domain signal of the original air conduction signal, and obtaining the air conduction audio signal based on the original air conduction signal and the frequency domain signal of the original air conduction signal; and performing short-time Fourier transformation on the original bone conduction signal to obtain a frequency domain signal of the original bone conduction signal, and obtaining the bone conduction audio signal based on the original bone conduction signal and the frequency domain signal of the original bone conduction signal.

The air conduction microphone and the bone conduction microphone may synchronously collect the original air conduction signal and the original bone conduction signal, so that the collected original air conduction signal and original bone conduction signal are time domain signals. For example, during a user's call, the air conduction microphone collects a sound signal in real time to obtain an original air conduction signal, and the bone conduction microphone collects a sound signal in real time to obtain an original bone conduction signal.

To introduce frequency domain transformation, the original air conduction signal and the original bone conduction signal may be transformed to a frequency domain through short-time Fourier transformation, to obtain frequency domain signals of the original air conduction signal and the original bone conduction signal, where the original air conduction signal and the original bone conduction signal are time domain signals. By combining the original air conduction signal and the frequency domain signal of the original air conduction signal, a time-frequency domain air conduction audio signal may be obtained. By combining the original bone conduction signal and the frequency domain signal of the original bone conduction signal, a time-frequency domain bone conduction audio signal may be obtained. Therefore, the original air conduction signal and the original bone conduction signal are transformed to the time-frequency domain, so as to introduce frequency domain information in subsequent model processing.

In the foregoing example, through the short-time Fourier transformation, the original bone conduction signal and original air conduction signal in the time domain may be transformed into the bone conduction audio signal and air conduction audio signal in the time-frequency domain with more information content before being input into the model, so that the model may learn the frequency domain information of the bone conduction audio signal and the air conduction audio signal to output more accurate prediction results.

In one example, obtaining a target audio signal based on the predicted amplitude includes: multiplying the predicted amplitude by a phase of the air conduction audio signal to obtain a multiplication result as a time-frequency domain enhanced signal; and performing inverse short-time Fourier transformation on the enhanced signal to obtain the target audio signal.

If feature transformation is used when the original air conduction signal and the original bone conduction signal are transformed to the time-frequency domain, after the time-frequency domain enhanced signal is obtained, the enhanced signal may be processed by inverse transformation of the feature transformation, to transform the time-frequency domain enhanced signal to the time domain and obtain the target audio signal that can be directly heard.

If the feature transformation is short-time Fourier transformation, after the time-frequency domain enhanced signal is obtained, inverse short-time Fourier transformation may be performed on the enhanced signal to obtain the target audio signal.

In the foregoing example, through the short-time Fourier transformation and the inverse short-time Fourier transformation, the signals of bone conduction and air conduction may be transformed back and forth between the time domain and the time-frequency domain. After the model obtains the desired predicted amplitude, the inverse transformation from the time-frequency domain to the time domain may be performed to obtain the clear target audio signal.

In one example, there may be a plurality of air conduction microphones on a device, and when original air conduction signals are collected based on the air conduction microphones, original air conduction signals may be collected from different directions based on the plurality of air conduction microphones to obtain a plurality of air conduction signals.

The present application does not limit the quantity of the air conduction microphone. In the presence of a plurality of air conduction microphones, the air conduction microphones may be installed in different orientations to collect original air conduction signals from different directions, so as to obtain a plurality of original air conduction signals from different directions.

Taking earphones as an example, a plurality of air conduction microphones may be installed in different orientations (such as front, back, left, right, up, and down) on the same earphones, and the plurality of air conduction microphones may collect sound signals from a plurality of directions of the earphones according to the orientations during installation, to obtain a plurality of original air conduction signals. Due to the different collection directions, the sound included in the plurality of original air conduction signals and the intensity and orientation of the sound are different, thereby increasing the volume of sound information included in the original air conduction signals. In some cases, each sound can be located more accurately, thereby improving audio quality and facilitating audio processing such as restoring stereo sound.

In one example, the plurality of air conduction microphones include a single-directional air conduction microphone and an all-directional air conduction microphone, and collecting original air conduction signals from different directions based on the plurality of air conduction microphones to obtain a plurality of original air conduction signals includes: determining a target direction where sound signals are greater than a preset decibel threshold, and directionally collecting a sound signal in the target direction based on the single-directional air conduction microphone to obtain a single-directional original air conduction signal; and collecting sound signals in all directions based on the all-directional air conduction microphone to obtain all-directional original air conduction signals.

In an example, the plurality of air conduction microphones configured in the device may include a single-directional air conduction microphone and an all-directional air conduction microphone. The all-directional air conduction microphone collects sound signals in all directions to obtain all-directional original air conduction signals. For example, during a user's call, the bone conduction microphone collects a user's sound signal to obtain an original bone conduction signal, the single-directional air conduction microphone directionally collects a sound signal in a user's direction to obtain a single-directional original air conduction signal, and the all-directional air conduction microphone collects sound signals in all directions of a user's environment to obtain all-directional original air conduction microphone signals. The sound signals in all directions of the user's environment may include both user's sound signals and background sound signals of the user's environment.

When sound signals in a direction or some directions are collected through the single-directional air conduction microphone, the target direction of the sounding object (such as user) may be determined by the volume of sound. For example, a decibel threshold is preset, and sound signals in different directions are continuously monitored. When a sound signal greater than the preset decibel threshold is monitored, a target direction where the sound signal greater than the preset decibel threshold is located is determined, and a sound signal in the target direction is directionally collected by the single-directional air conduction microphone to obtain the sound signal of the sounding object as a single-directional original air conduction signal.

In some cases, specific collection objects may not be configured. Sound signals in different directions may be continuously monitored. When a sound signal greater than the preset decibel threshold is monitored, the sound signal greater than the preset decibel threshold is used as a collection object, and the sound signal greater than the preset decibel threshold is directionally collected by the single-directional air conduction microphone to obtain a single-directional original air conduction signal.

In the foregoing example, the single-directional air conduction microphone serves as a main air conduction microphone to collect relatively pure audio signals, thereby ensuring a relatively high signal-to-noise ratio to facilitate the extraction of target sound by the model during processing. The all-directional air conduction microphone serves as an auxiliary air conduction microphone, thereby utilizing the characteristic of no frequency band omission in air conduction to ensure the integrity of the audio signals input to the model; and the two cooperate to improve the accuracy of the predicted amplitude output by the model.

In one example, the air conduction audio signal is plural, and the process of performing short-time Fourier transformation on the original air conduction signal to obtain a frequency domain signal of the original air conduction signal and obtaining an air conduction audio signal based on the original air conduction signal and the frequency domain signal of the original air conduction signal includes: performing short-time Fourier transformation on the plurality of original air conduction signals to obtain frequency domain signals of the original air conduction signals, and obtaining a plurality of air conduction audio signals based on the original air conduction signals and the corresponding frequency domain signals.

The plurality of air conduction audio signals include a single-directional air conduction audio signal transformed from the single-directional original air conduction signal.

The air conduction microphone and the all-directional air conduction microphone may synchronously collect a plurality of original air conduction signals. When short-time Fourier transformation is performed on the original air conduction signal to obtain a frequency domain signal of the original air conduction signal, and an air conduction audio signal is obtained based on the original air conduction signal and the frequency domain signal of the original air conduction signal, each original air conduction signal may be processed. For example, one microphone collects one signal. The single-directional original air conduction signal collected by each single-directional air conduction microphone may be transformed into a frequency domain signal through short-time Fourier transformation, and a single-directional air conduction audio signal is obtained based on each single-directional original air conduction signal and its frequency domain signal. The all-directional original air conduction signal collected by each all-directional air conduction microphone may be transformed into a frequency domain signal through short-time Fourier transformation, and an all-directional air conduction audio signal is obtained based on each all-directional original air conduction signal and its frequency domain signal.

It may be understood that the present application does not limit the quantities of single-directional air conduction microphones, all-directional air conduction microphones, single-directional original air conduction signals, all-directional original air conduction signals, single-directional air conduction audio signals, and all-directional air conduction audio signals.

In one example, the process of multiplying the predicted amplitude by a phase of the air conduction audio signal to obtain a multiplication result as a time-frequency domain enhanced signal includes: multiplying the predicted amplitude by a phase of the single-directional air conduction audio signal to obtain a multiplication result as the time-frequency domain enhanced signal.

When both the single-directional air conduction microphone and the all-directional air conduction microphone are configured in the device, obtaining a time-frequency domain enhanced signal based on the predicted amplitude includes: multiplying the predicted amplitude by the phase of the single-directional air conduction audio signal to obtain a multiplication result as the time-frequency domain enhanced signal.

If there is a plurality of single-directional air conduction microphones, one single-directional air conduction microphone may be determined from the single-directional air conduction microphones as a main air conduction microphone. The predicted amplitude is multiplied by the phase of the single-directional air conduction audio signal corresponding to the main air conduction microphone, and the multiplication result is used as the time-frequency domain enhanced signal. For example, the distance between each single-directional air conduction microphone and the sounding object may be acquired, and the single-directional air conduction microphone closest to the sounding object may be used as the main air conduction microphone. For another example, an average value of the original air conduction signals collected by each single-directional air conduction microphone may be determined, and the single-directional air conduction microphone with the maximum average value of the collected original air conduction signals may be used as the main air conduction microphone.

In the foregoing example, the plurality of air conduction microphones may be used to collect original air conduction signals, whereby the characteristic of different collection directions of the plurality of air conduction microphones is combined with the multi-microphone audio enhancement technology to further increase the volume of information that the model may process, so that the model can output more accurate predicted amplitudes based on more information.

In one example, before inputting the voiceprint feature of the bone conduction audio signal, the first audio feature, and the second audio feature into a trained amplitude prediction model to obtain a predicted amplitude, the method further includes: acquiring an air conduction audio signal sample and a bone conduction audio signal sample; acquiring a third audio feature of the air conduction audio signal sample and a fourth audio feature of the bone conduction audio signal sample; using the bone conduction audio signal sample as input data for a feature extraction model, using output of the feature extraction model, the third audio feature, and the fourth audio feature as input data for an amplitude prediction model, and using an amplitude of the air conduction audio signal sample as target output of the amplitude prediction model, to perform fusion training on the feature extraction model and the amplitude prediction model to obtain the trained feature extraction model and the trained amplitude prediction model.

Before the trained amplitude prediction model is used to obtain the predicted amplitude, the amplitude prediction model is first constructed, and the constructed amplitude prediction model is trained. The data pre-processing step when the amplitude prediction model is trained may be the same as the data pre-processing step when the amplitude prediction model is used. For example, the specific description of acquiring an air conduction audio signal sample and a bone conduction audio signal sample may be referenced to the relevant description of acquiring an air conduction audio signal and a bone conduction audio signal in the foregoing examples, and the specific description of acquiring a third audio feature of the air conduction audio signal sample and a fourth audio feature of the bone conduction audio signal sample may be referenced to the relevant description of acquiring a first audio feature of the air conduction audio signal and a second audio feature of the bone conduction audio signal in the foregoing examples.

For example, when an air conduction audio signal sample and a bone conduction audio signal sample are acquired, an original air conduction signal sample is acquired based on an air conduction microphone, and an original bone conduction signal sample is collected based on a bone conduction microphone. A single-directional original air conduction signal sample is directionally collected based on a single-directional air conduction microphone, and an all-directional original air conduction signal sample is collected based on an all-directional air conduction microphone. Short-time Fourier transformation is performed on the original air conduction signal sample to obtain a frequency domain signal sample of the original air conduction signal sample, and an air conduction audio signal sample is obtained based on the original air conduction signal sample and the frequency domain signal sample of the original air conduction signal sample. Short-time Fourier transformation is performed on the original bone conduction signal sample to obtain a frequency domain signal sample of the original bone conduction signal sample, and a bone conduction audio signal sample is obtained based on the original bone conduction signal sample and the frequency domain signal sample of the original bone conduction signal sample.

The third audio feature and the fourth audio feature are audio features of the air conduction audio signal sample and the bone conduction audio signal sample respectively, and the third audio feature, the fourth audio feature, the first audio feature, and the second audio feature are the same type of audio features. For example, all the audio features are amplitude and phase.

In one example, the dual models of the present application are trained by a fusion training method. The bone conduction audio signal sample may be used as input data for the feature extraction model, and the output of the feature extraction model, the third audio feature, and the fourth audio feature are used as input data for the amplitude prediction model, to perform fusion training on the feature extraction model and the amplitude prediction model. The data processing methods when the feature extraction model and the amplitude prediction model may be trained may be referenced to the relevant descriptions in the examples of the foregoing audio enhancement method, and will not be repeated here.

The target output of fusion training may be determined according to actual needs. If the bone conduction audio signal needs to be enhanced, the amplitude of the bone conduction audio signal sample is used as the target output of the amplitude prediction model; and if the air conduction audio signal needs to be enhanced, the amplitude of the air conduction audio signal sample is used as the target output of the amplitude prediction model. When there is a plurality of air conduction microphones in the device and a plurality of air conduction original signal samples are collected, the amplitude of the air conduction audio signal sample corresponding to the original air conduction signal sample of the main air conduction microphone is used as the target output.

When fusion training is performed on the feature extraction model and the amplitude prediction model, only one set of loss function is set for the feature extraction model and the amplitude prediction model. The amplitude prediction model continuously obtains predicted output based on the output of the feature extraction model. The predicted output of the feature extraction model is compared with the target output corresponding to the input data based on the set loss function, and the loss value of the loss function is continuously reduced to synchronously optimize the feature extraction model and the amplitude prediction model, so as to achieve the purpose of fusion training.

In the foregoing example, the feature extraction model and the amplitude prediction model learn the output of the feature extraction model and the relationship between the audio features of the air conduction audio signal sample and bone conduction audio signal sample and the amplitude of the air conduction audio signal sample through fusion training. The trained dual models may be used to predict a desired amplitude of an audio in audio enhancement, thereby achieving audio enhancement and improving audio quality.

In an example, as shown in FIG. 3, a fusion training method is provided. The method may be applied to the terminal in FIG. 1 as an example for explanation, and includes steps S302 to S306 below.
Step S302: Acquire an air conduction audio signal sample and a bone conduction audio signal sample.
Step S304: Acquire a third audio feature of the air conduction audio signal sample and a fourth audio feature of the bone conduction audio signal sample.
Step S306: Use the bone conduction audio signal sample as input data for a feature extraction model, use output of the feature extraction model, the third audio feature, and the fourth audio feature as input data for an amplitude prediction model, and use an amplitude of the air conduction audio signal sample as target output of the amplitude prediction model, to perform fusion training on the feature extraction model and the amplitude prediction model to obtain a trained feature extraction model and a trained amplitude prediction model.

In one example, acquiring an air conduction audio signal sample and a bone conduction audio signal sample includes: collecting an original air conduction signal sample based on an air conduction microphone, and collecting an original bone conduction signal sample based on a bone conduction microphone, where a single-directional original air conduction signal sample is directionally collected based on a single-directional air conduction microphone, and an all-directional original air conduction signal sample is collected based on an all-directional air conduction microphone; performing short-time Fourier transformation on the original air conduction signal sample to obtain a frequency domain signal sample of the original air conduction signal sample, and obtaining the air conduction audio signal sample based on the original air conduction signal sample and the frequency domain signal sample of the original air conduction signal sample; performing short-time Fourier transformation on the original bone conduction signal sample to obtain a frequency domain signal sample of the original bone conduction signal sample, and obtaining the bone conduction audio signal sample based on the original bone conduction signal sample and the frequency domain signal sample of the original bone conduction signal sample.

According to the foregoing fusion training method, the air conduction audio signal sample and the bone conduction audio signal sample are acquired. The third audio feature of the air conduction audio signal sample and the fourth audio feature of the bone conduction audio signal sample are acquired. The bone conduction audio signal sample is used as input data for the feature extraction model, the output of the feature extraction model, the third audio feature, and the fourth audio feature are used as input data for the amplitude prediction model, and the amplitude of the air conduction audio signal sample is used as target output of the amplitude prediction model, to perform fusion training on the feature extraction model and the amplitude prediction model to obtain the trained feature extraction model and the trained amplitude prediction model. The audio signal collected through air conduction has a wide frequency range, while the audio signal collected through bone conduction is almost not interfered by environmental noise.

The present application designs and trains a dual model mechanism, where the primary model may be used to extract a voiceprint feature from a bone conduction audio signal, and the extracted voiceprint feature continues the advantage of low bone conduction noise and can assist in noise reduction. The secondary model may fuse the voiceprint feature output by the primary model with the audio features of the air conduction audio signal and the bone conduction audio signal. The primary model and the secondary model learn the output of the feature extraction model and the relationship between the audio features of the air conduction audio signal sample and bone conduction audio signal sample and the amplitude of the air conduction audio signal sample through fusion training. The trained dual models may be used to predict a desired amplitude of an audio in audio enhancement, thereby achieving audio enhancement and improving audio quality.

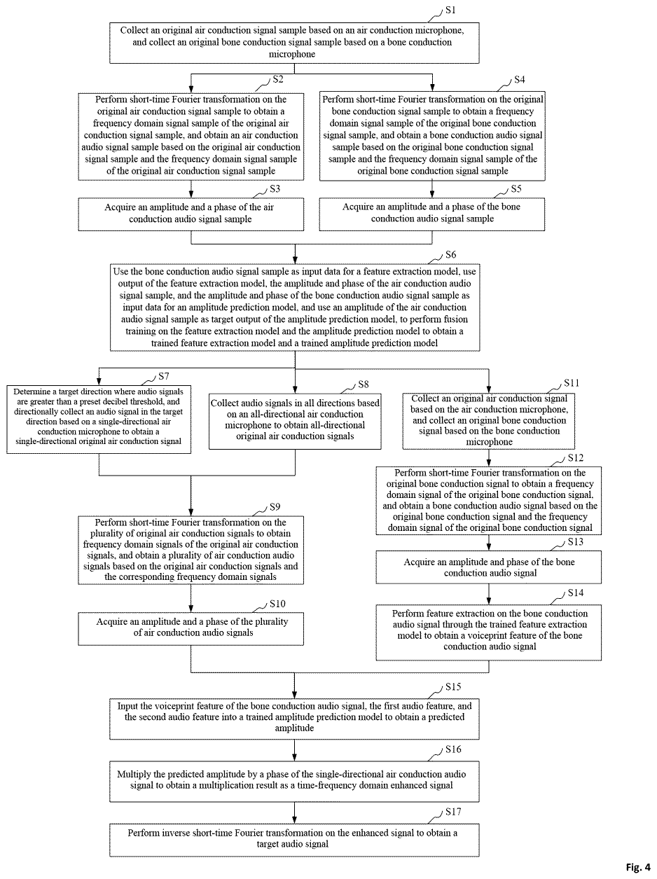

The present application further provides a specific example, as shown in FIG. 4. The specific example of the audio enhancement method and the fusion training method can be performed by a computer device as described herein and may comprise the following steps:
S1: Collect an original air conduction signal sample based on an air conduction microphone, and collect an original bone conduction signal sample based on a bone conduction microphone.

A single-directional original air conduction signal sample is directionally collected based on a single-directional air conduction microphone, and an all-directional original air conduction signal sample is collected based on an all-directional air conduction microphone.
S2: Perform short-time Fourier transformation on the original air conduction signal sample to obtain a frequency domain signal sample of the original air conduction signal sample, and obtain an air conduction audio signal sample based on the original air conduction signal sample and the frequency domain signal sample of the original air conduction signal sample.
S3: Acquire an amplitude and a phase of the air conduction audio signal sample.
S4: Perform short-time Fourier transformation on the original bone conduction signal sample to obtain a frequency domain signal sample of the original bone conduction signal sample, and obtain a bone conduction audio signal sample based on the original bone conduction signal sample and the frequency domain signal sample of the original bone conduction signal sample.
S5: Acquire an amplitude and a phase of the bone conduction audio signal sample.
S6: Use the bone conduction audio signal sample as input data for a feature extraction model, use output of the feature extraction model, the amplitude and phase of the air conduction audio signal sample, and the amplitude and phase of the bone conduction audio signal sample as input data for an amplitude prediction model, and use an amplitude of the air conduction audio signal sample as target output of the amplitude prediction model, to perform fusion training on the feature extraction model and the amplitude prediction model to obtain a trained feature extraction model and a trained amplitude prediction model.
S7: Determine a target direction where audio signals are greater than a preset decibel threshold, and directionally collect an audio signal in the target direction based on a single-directional air conduction microphone to obtain a single-directional original air conduction signal.
S8: Collect audio signals in all directions based on an all-directional air conduction microphone to obtain all-directional original air conduction signals.
S9: Perform short-time Fourier transformation on the plurality of original air conduction signals to obtain frequency domain signals of the original air conduction signals, and obtain a plurality of air conduction audio signals based on the original air conduction signals and the corresponding frequency domain signals.

The plurality of air conduction audio signals include a single-directional air conduction audio signal transformed from the single-directional original air conduction signal.

An original air conduction signal m_{q} with a length of T in a time domain may be represented as m_{q}(t), where t represents time and 0<t≤T. The original air conduction signal m_{q}(t) in the time domain is transformed to a time-frequency domain through short-time Fourier transformation to obtain an air conduction audio signal, expressed as equation (1):

$${M}_{q} ( n , k ) = STFT ( {m}_{q} ( t ) ) \qquad ( 1 )$$

Where n represents a frame sequence, 0<n≤N, N represents a total number of frames, k represents a center frequency sequence, 0<k≤K, and K represents a total number of frequency points. Where q represents an air conduction microphone, 0<q≤Q, and Q represents a total number of original air conduction signals. In some cases, Q is also equal to the total number of air conduction microphones.

When one air conduction microphone is configured in the device, Q=1, an original air conduction signal is collected through the air conduction microphone, and the original air conduction signal is transformed to a time-frequency domain through short-time Fourier transformation to obtain an air conduction audio signal. When a plurality of air conduction microphones are configured in the device, Q>1, original air conduction signals are collected through the plurality of air conduction microphones, and the original air conduction signals are transformed to a time-frequency domain through short-time Fourier transformation to obtain a plurality of air conduction audio signals.
S10: Acquire an amplitude and a phase of the plurality of air conduction audio signals.

The acquired amplitude Mag of the plurality of air conduction audio signals M_{q}(n,k) may be expressed as equation (2), and the acquired phase Pha of the plurality of air conduction audio signals M_{q}(n,k) may be expressed as equation (3):

$${MagM}_{q} ( n , k ) = abs ( {M}_{q} ( n , k ) ) \qquad ( 2 )$$

$${PhaM}_{q} ( n , k ) = {M}_{q} ( n , k ) / abs ( {M}_{q} ( n , k ) ) \qquad ( 3 )$$

S11: Collect an original air conduction signal based on the air conduction microphone, and collect an original bone conduction signal based on the bone conduction microphone.
S12: Perform short-time Fourier transformation on the original bone conduction signal to obtain a frequency domain signal of the original bone conduction signal, and obtain a bone conduction audio signal based on the original bone conduction signal and the frequency domain signal of the original bone conduction signal.

The original bone conduction signal v with a length of T in the time domain may be represented as v(t), where t represents time and 0<t≤T. The original bone conduction signal v(t) in the time domain is transformed to the time-frequency domain through short-time Fourier transformation to obtain the bone conduction audio signal, expressed as equation (4):

$$V ( n , k ) = STFT ( v ( t ) ) \qquad ( 4 )$$

Where n represents a frame sequence of the bone conduction audio signal, 0<n≤N, N represents a total number of frames, k represents a center frequency sequence, 0<k≤K, and K represents a total number of frequency points.
S13: Acquire an amplitude and phase of the bone conduction audio signal.

The acquired amplitude Mag of the bone conduction audio signal V(n,k) may be expressed as equation (5), and the acquired phase Pha of the bone conduction audio signal V(n,k) may be expressed as equation (6):

$$MagV ( n , k ) = abs ( V ( n , k ) ) \qquad ( 5 )$$

$$PhaV ( n , k ) = V ( n , k ) / abs ( V ( n , k ) ) \qquad ( 6 )$$

S14: Perform feature extraction on the bone conduction audio signal through the trained feature extraction model to obtain a voiceprint feature of the bone conduction audio signal.

The extracted voiceprint feature of the bone conduction audio signal V(n,k) may be represented as DNN1(V(n,k)).
S15: Input the voiceprint feature of the bone conduction audio signal, the first audio feature, and the second audio feature into the trained amplitude prediction model to obtain a predicted amplitude.

The voiceprint features DNN1(V(n,k)) of the bone conduction audio signal, the amplitude MagV(n,k) and phase PhaV(n,k) of the bone conduction audio signal, and the amplitude MagM_{q}(n,k) and phase PhaM_{q}(n,k) of the air conduction audio signal are input into the trained amplitude prediction model to obtain the predicted amplitude Mag(n,k). This process may be expressed as equation (7):

$$Mag ( n , k ) = DNN 2 [ Mq ( n , k ) , V ( n , k ) , DNN 1 ( V ( n , k ) ) ] \qquad ( 7 )$$

S16: Multiply the predicted amplitude by a phase of the single-directional air conduction audio signal to obtain a multiplication result as a time-frequency domain enhanced signal.
S17: Perform inverse short-time Fourier transformation on the enhanced signal to obtain a target audio signal.

The process of multiplying the predicted amplitude Mag(n,k) by the phase PhaM₁(n,k) of the single-directional air conduction audio signal may be expressed as equation (8).

$$X ( t ) = ISTFT ( Mag ( n , k ) * {PhaM}_{1} ( n , k ) ) \qquad ( 8 )$$

X(t) represents a final enhanced result, e.g., the target audio signal.

In the foregoing example, the audio signal collected through air conduction has a wide frequency range, while the audio signal collected through bone conduction is almost not interfered by environmental noise. The present application designs and trains a dual model mechanism, where the primary model and the secondary model learn the output of the feature extraction model and the relationship between the audio features of the air conduction audio signal sample and bone conduction audio signal sample and the amplitude of the air conduction audio signal sample through fusion training. The trained primary model may extract a voiceprint feature from a bone conduction audio signal, and the extracted voiceprint feature continues the advantage of low bone conduction noise and can assist in noise reduction. The voiceprint feature and the audio features of the air conduction audio signal and bone conduction audio signal are fused in the trained secondary model to obtain the predicted amplitude, where the predicted amplitude may be used to generate an enhanced audio signal. The advantages of bone conduction and air conduction are fused through the trained dual models to output an appropriate predicted amplitude, so that the target audio signal obtained based on the predicted amplitude does not lose the frequency band, noise reduction is achieved, and the audio quality is improved.

The parts not detailed in the foregoing fusion training method may be referenced to the relevant descriptions of the audio enhancement method in the present application, and will not be repeated here.

It should be understood that the various steps in the flowcharts involved in the above examples are displayed in sequence indicated by arrows, but these steps are not necessarily executed in such sequence. Unless otherwise explicitly specified herein, these steps are not limited in a strict sequence, but may be executed in other sequences. Moreover, at least some of the steps in the flowcharts involved in the above examples may include a plurality of steps or stages, these steps or stages are not necessarily completed at the same time but may be executed at different time, the execution of these steps or stages is not necessarily sequential, but these steps or stages may be alternately executed with at least part of other steps or stages.

An example of the present application further provides an audio enhancement apparatus for implementing the foregoing audio enhancement method. The implementation scheme provided by the apparatus to solve the problems is similar to the implementation scheme described in the foregoing method. Therefore, the specific limitations in one or more examples of the audio enhancement apparatus provided below may be referenced to the limitations in the audio enhancement method above, and will not be repeated here.

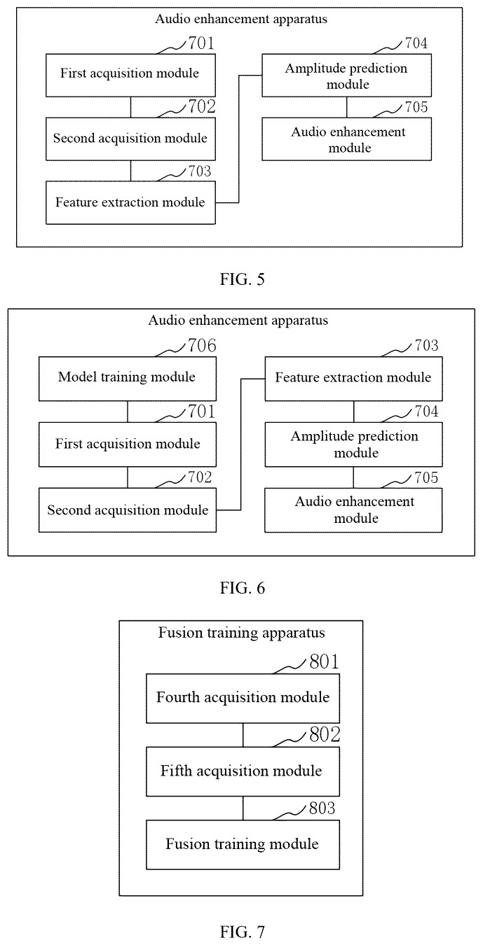

In an example, as shown in FIG. 5, an audio enhancement apparatus is provided, including: a first acquisition module 701, a second acquisition module 702, a feature extraction module 703, an amplitude prediction module 704, and an audio enhancement module 705.

The first acquisition module 701 is configured to acquire an air conduction audio signal and a bone conduction audio signal;

The second acquisition module 702 is configured to acquire a first audio feature of the air conduction audio signal and a second audio feature of the bone conduction audio signal;

The feature extraction module 703 is configured to perform feature extraction on the bone conduction audio signal through a trained feature extraction model to obtain a voiceprint feature of the bone conduction audio signal;

The amplitude prediction module 704 is configured to input the voiceprint feature of the bone conduction audio signal, the first audio feature, and the second audio feature into a trained amplitude prediction model to obtain a predicted amplitude;

The audio enhancement module 705 is configured to obtain a target audio signal based on the predicted amplitude.

In one example, the first acquisition module 701 is further configured to: collect an original air conduction signal based on an air conduction microphone, and collect an original bone conduction signal based on a bone conduction microphone; perform short-time Fourier transformation on the original air conduction signal to obtain a frequency domain signal of the original air conduction signal, and obtain the air conduction audio signal based on the original air conduction signal and the frequency domain signal of the original air conduction signal; and perform short-time Fourier transformation on the original bone conduction signal to obtain a frequency domain signal of the original bone conduction signal, and obtain the bone conduction audio signal based on the original bone conduction signal and the frequency domain signal of the original bone conduction signal.

In one example, when audio is enhanced based on the predicted amplitude to obtain the target audio signal, the audio enhancement module 705 is further configured to: multiply the predicted amplitude by a phase of the air conduction audio signal to obtain a multiplication result as a time-frequency domain enhanced signal; and perform inverse short-time Fourier transformation on the enhanced signal to obtain the target audio signal.

In one example, the first acquisition module 701 is further configured to: collect original air conduction signals from different directions based on a plurality of air conduction microphones to obtain a plurality of original air conduction signals.

In one example, the plurality of air conduction microphones include a single-directional air conduction microphone and an all-directional air conduction microphone, and when original air conduction signals are collected from different directions based on the plurality of air conduction microphones to obtain a plurality of original air conduction signals, the first acquisition module 701 is further configured to: determine a target direction where audio signals are greater than a preset decibel threshold, and directionally collect an audio signal in the target direction based on the single-directional air conduction microphone to obtain a single-directional original air conduction signal; and collect audio signals in all directions based on the all-directional air conduction microphone to obtain all-directional original air conduction signals.

In one example, the air conduction audio signal is plural, and when short-time Fourier transformation is performed on the original air conduction signal to obtain a frequency domain signal of the original air conduction signal and an air conduction audio signal is obtained based on the original air conduction signal and the frequency domain signal of the original air conduction signal, the first acquisition module 701 is further configured to: perform short-time Fourier transformation on the plurality of original air conduction signals to obtain frequency domain signals of the original air conduction signals, and obtain a plurality of air conduction audio signals based on the original air conduction signals and the corresponding frequency domain signals, where the plurality of air conduction audio signals include a single-directional air conduction audio signal transformed from the single-directional original air conduction signal;

The process of multiplying the predicted amplitude by a phase of the air conduction audio signal to obtain a multiplication result as a time-frequency domain enhanced signal includes: multiplying the predicted amplitude by a phase of the single-directional air conduction audio signal to obtain a multiplication result as the time-frequency domain enhanced signal.

In one example, as shown in FIG. 6, the audio enhancement apparatus further includes a model training module 706, and before the voiceprint feature of the bone conduction audio signal, the first audio feature, and the second audio feature are input into a trained amplitude prediction model to obtain a predicted amplitude, the model training module 706 is configured to: acquire an air conduction audio signal sample and a bone conduction audio signal sample; acquire a third audio feature of the air conduction audio signal sample and a fourth audio feature of the bone conduction audio signal sample; and use the bone conduction audio signal sample as input data for a feature extraction model, use output of the feature extraction model, the third audio feature, and the fourth audio feature as input data for an amplitude prediction model, and use an amplitude of the air conduction audio signal sample as target output of the amplitude prediction model, to perform fusion training on the feature extraction model and the amplitude prediction model to obtain the trained feature extraction model and the trained amplitude prediction model.

In one example, when the air conduction audio signal sample and the bone conduction audio signal sample are acquired, the model training module 706 is further configured to: collect an original air conduction signal sample based on the air conduction microphone, and collect an original bone conduction signal sample based on the bone conduction microphone, where a single-directional original air conduction signal sample is directionally collected based on the single-directional air conduction microphone, and an all-directional original air conduction signal sample is collected based on the all-directional air conduction microphone; perform short-time Fourier transformation on the original air conduction signal sample to obtain a frequency domain signal sample of the original air conduction signal sample, and obtain the air conduction audio signal sample based on the original air conduction signal sample and the frequency domain signal sample of the original air conduction signal sample; and perform short-time Fourier transformation on the original bone conduction signal sample to obtain a frequency domain signal sample of the original bone conduction signal sample, and obtain the bone conduction audio signal sample based on the original bone conduction signal sample and the frequency domain signal sample of the original bone conduction signal sample.

According to the foregoing audio enhancement apparatus, the first acquisition module 701 acquires the air conduction audio signal and the bone conduction audio signal; the second acquisition module 702 acquires the first audio feature of the air conduction audio signal and the second audio feature of the bone conduction audio signal; the feature extraction module 703 performs feature extraction on the bone conduction audio signal through the trained feature extraction model to obtain the voiceprint feature of the bone conduction audio signal; the amplitude prediction module 704 inputs the voiceprint feature of the bone conduction audio signal, the first audio feature, and the second audio feature into the trained amplitude prediction model to obtain the predicted amplitude; and the audio enhancement module 705 obtains the target audio signal based on the predicted amplitude. The audio signal collected through air conduction has a wide frequency range, while the audio signal collected through bone conduction is almost not interfered by environmental noise. In the present application, the primary model is utilized to extract the voiceprint feature from the bone conduction audio signal, so the extracted voiceprint feature continues the advantage of low bone conduction noise and can assist in noise reduction. The voiceprint feature and the audio features of the air conduction audio signal and the bone conduction audio signal are fused in the pre-trained secondary model to obtain the predicted amplitude, where the predicted amplitude may be used to generate an enhanced audio signal. The dual model mechanism of the present application integrates the advantages of bone conduction and air conduction, whereby the obtained target audio signal does not lose the frequency band and noise reduction is achieved, thereby improving audio quality.

In an example, as shown in FIG. 7, a fusion training apparatus is provided, including: a fourth acquisition module 801, a fifth acquisition module 802, and a fusion training module 803.

The fourth acquisition module 801 is configured to acquire an air conduction audio signal sample and a bone conduction audio signal sample.

The fifth acquisition module 802 is configured to acquire a third audio feature of the air conduction audio signal sample and a fourth audio feature of the bone conduction audio signal sample.

The fusion training module 803 is configured to use the bone conduction audio signal sample as input data for a feature extraction model, use output of the feature extraction model, the third audio feature, and the fourth audio feature as input data for an amplitude prediction model, and use an amplitude of the air conduction audio signal sample as target output of the amplitude prediction model, to perform fusion training on the feature extraction model and the amplitude prediction model to obtain a trained feature extraction model and a trained amplitude prediction model.

In one example, when the air conduction audio signal sample and the bone conduction audio signal sample are acquired, the fourth acquisition module 801 is further configured to:
(i) collect an original air conduction signal sample based on an air conduction microphone, and collect an original bone conduction signal sample based on a bone conduction microphone, where a single-directional original air conduction signal sample is directionally collected based on a single-directional air conduction microphone, and an all-directional original air conduction signal sample is collected based on an all-directional air conduction microphone;
(ii) perform short-time Fourier transformation on the original air conduction signal sample to obtain a frequency domain signal sample of the original air conduction signal sample, and obtain the air conduction audio signal sample based on the original air conduction signal sample and the frequency domain signal sample of the original air conduction signal sample; and
(iii) perform short-time Fourier transformation on the original bone conduction signal sample to obtain a frequency domain signal sample of the original bone conduction signal sample, and obtain the bone conduction audio signal sample based on the original bone conduction signal sample and the frequency domain signal sample of the original bone conduction signal sample.

According to the foregoing fusion training apparatus, the fourth acquisition module 801 acquires the air conduction audio signal sample and the bone conduction audio signal sample; the fifth acquisition module 802 acquires the third audio feature of the air conduction audio signal sample and the fourth audio feature of the bone conduction audio signal sample; and the fusion training module 803 uses the bone conduction audio signal sample as input data for the feature extraction model, use output of the feature extraction model, the third audio feature, and the fourth audio feature as input data for the amplitude prediction model, and use the amplitude of the air conduction audio signal sample as target output of the amplitude prediction model, to perform fusion training on the feature extraction model and the amplitude prediction model to obtain the trained feature extraction model and the trained amplitude prediction model. The audio signal collected through air conduction has a wide frequency range, while the audio signal collected through bone conduction is almost not interfered by environmental noise.

The present application designs and trains a dual model mechanism, where the primary model may be used to extract a voiceprint feature from a bone conduction audio signal, and the extracted voiceprint feature continues the advantage of low bone conduction noise and can assist in noise reduction. The secondary model may fuse the voiceprint feature output by the primary model with the audio features of the air conduction audio signal and the bone conduction audio signal. The primary model and the secondary model learn the output of the feature extraction model and the relationship between the audio features of the air conduction audio signal sample and bone conduction audio signal sample and the amplitude of the air conduction audio signal sample through fusion training. The trained dual models may be used to predict a desired amplitude of an audio in audio enhancement, thereby achieving audio enhancement and improving audio quality.

The various modules in the foregoing audio enhancement apparatus and fusion training apparatus may be fully or partially implemented through software, hardware, and a combination thereof. The foregoing modules may be embedded in or independent of a processor in a computer device in a form of hardware, or stored in a memory of a computer device in a form of software, whereby the processor calls the modules to perform operations corresponding to the modules.

The terms “component”, “module”, and “system” are intended to represent computer related entities, and may be hardware, a combination of hardware and software, software, or software being executed. For example, the component may be, but is not limited to, a process, processor, object, executable code, executed thread, program, and/or computer running on a processor. As an illustration, both the program running on the server and the server may be components. One or more components may reside in a process and/or executed thread, and the components may be located in one computer and/or distributed between two or more computers.

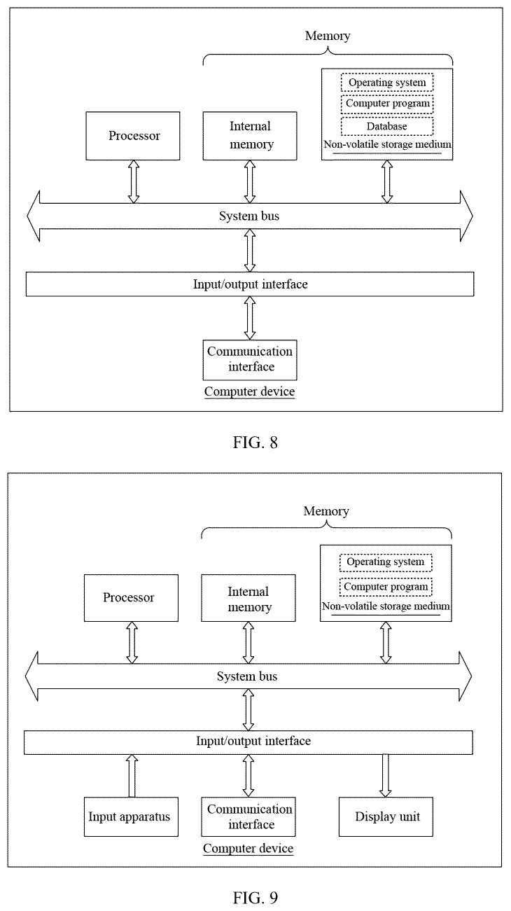

In an example, a computer device is provided. The computer device may be a server, and its internal structure may be as shown in FIG. 8. The computer device includes a processor, a memory, an input/output (I/O) interface, and a communication interface. The processor, the memory, and the input/output interface are connected by a system bus, and the communication interface is connected to the system bus by the input/output interface. The processor of the computer device is configured to provide computing and control capabilities. The memory of the computer device includes a non-volatile computer-readable storage medium and an internal memory. The non-volatile computer-readable storage medium stores an operating system, computer-readable instructions, and a database. The internal memory provides an environment for the operation of the operating system and the computer-readable instructions in the non-volatile computer-readable storage medium. The input/output interface of the computer device is configured to exchange information between the processor and an external device. The communication interface of the computer device is configured to communicate with an external terminal through network connection. The computer-readable instructions, when executed by the processor, implement the audio enhancement method.

In an example, a computer device is provided. The computer device may be a terminal, and its internal structure may be as shown in FIG. 9. The computer device includes a processor, a memory, an input/output interface, a communication interface, a display unit, and an input apparatus. The processor, the memory, and the input/output interface are connected through a system bus. The communication interface, the display unit, and the input apparatus are connected to the system bus through the input/output interface. The processor of the computer device is configured to provide computing and control capabilities. The memory of the computer device includes a non-volatile computer-readable storage medium and an internal memory. The non-volatile computer-readable storage medium stores an operating system and computer-readable instructions. The internal memory provides an environment for the operation of the operating system and the computer-readable instructions in the non-volatile computer-readable storage medium. The input/output interface of the computer device is configured to exchange information between the processor and an external device. The communication interface of the computer device is configured to communicate with an external terminal in a wired or wireless manner. The wireless manner may be implemented through WIFI, a mobile cellular network, near field communication (NFC), or other technologies. The computer-readable instructions, when executed by the processor, implement the audio enhancement method. The display unit of the computer device is configured to form visible images, and may be a display, a projection apparatus, or a virtual reality imaging apparatus. The display may be a liquid crystal display or an electronic ink display. The input apparatus of the computer device may be a touch layer covering the display, or a button, trackball, or touchpad disposed on a shell of the computer device, or an external keyboard, touchpad, or mouse.

A person skilled in the art may understand that the structures shown in FIG. 8 and FIG. 9 are merely partial block diagrams related to the solutions of the present application, and do not constitute limitations on the computer device to which the present application is applied. The specific computer device may include more or fewer components than those shown in the figures, or combine some components, or have different component arrangements.

In one example, a computer device is further provided, including a memory and a processor, the memory storing computer-readable instructions, and the processor, when executing the computer-readable instructions, implementing the steps of the method in the foregoing examples.

In one example, a computer-readable storage medium is provided, storing computer-readable instructions, the computer-readable instructions, when executed by a processor, implementing the steps of the method in the foregoing examples.

In one example, a computer program product is provided, the computer program product including computer-readable instructions, and the computer-readable instructions being stored in a computer-readable storage medium. A processor of a computer device reads the computer-readable instructions from the computer-readable storage medium, and the processor executes the computer-readable instructions, enabling the computer device to perform the steps of the method in the foregoing examples.

A person of ordinary kill in the art may understand that all or part of the process in the method of the foregoing examples may be accomplished by instructing relevant hardware through computer-readable instructions, where the computer-readable instructions may be stored in a non-volatile computer-readable storage medium, and the computer-readable instructions, when executed, may include the process of the method in the foregoing examples. Any reference to the memory, database, or other media used in each example provided by the present application may include at least one of a non-volatile memory and a volatile memory. The non-volatile memory may be a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may be a random access memory (RAM), an external cache, or the like. As an illustration and not a limitation, the RAM may be in various forms, such as a static random access memory (SRAM) or a dynamic random access memory (DRAM). The database involved in each example provided by the present application may include at least one of a relational database and a non-relational database. The non-relational database may include, but is not limited to, a blockchain-based distributed database and the like, without limitation herein. The processor involved in the various examples provided in the present application may be a general-purpose processor, a central processing unit, a graphics processing unit, a digital signal processor, a programmable logic device, a quantum computing-based data processing logic device, an artificial intelligence (AI) processor, etc., without limitation herein.

The technical features of the above examples may be combined in any way. To make the description concise, not all possible combinations of the technical features in the foregoing examples are described. However, as long as there is no contradiction in the combinations of these technical features, these combinations fall within the scope of the present application.

The above examples merely express several implementations of the present application, and their descriptions are more specific and detailed, but should not be understood as limiting the patent scope of the present application. It should be noted that a person of ordinary skill in the art may make variations and improvements without departing from the concept of the present application, and these variations and improvements all fall into the scope of protection of the present application. Therefore, the scope of protection of the present application should be subject to the appended claims.

What is claimed is:

1. An audio enhancement method, comprising:
acquiring an air conduction audio signal from an air conduction microphone and a bone conduction audio signal from a bone conduction microphone;
determining a first audio feature of the air conduction audio signal and a second audio feature of the bone conduction audio signal;
performing feature extraction on the bone conduction audio signal using a feature extraction model to obtain a voiceprint feature of the bone conduction audio signal;
inputting the voiceprint feature of the bone conduction audio signal, the first audio feature, and the second audio feature into an amplitude prediction model to obtain a predicted amplitude; and
obtaining a target audio signal based on the predicted amplitude.

2. The method according to claim 1, wherein the acquiring the air conduction audio signal and the bone conduction audio signal comprises:
collecting an original air conduction signal from the air conduction microphone, and collecting an original bone conduction signal from the bone conduction microphone;
performing short-time Fourier transformation on the original air conduction signal to obtain a frequency domain signal of the original air conduction signal;
acquiring, based on the original air conduction signal and the frequency domain signal of the original air conduction signal, the air conduction audio signal;
performing short-time Fourier transformation on the original bone conduction signal to obtain a frequency domain signal of the original bone conduction signal; and
acquiring, based on the original bone conduction signal and the frequency domain signal of the original bone conduction signal, the bone conduction audio signal.

3. The method according to claim 1, wherein the obtaining the target audio signal based on the predicted amplitude comprises:
multiplying the predicted amplitude by a phase of the air conduction audio signal to obtain a multiplication result as a time-frequency domain enhanced signal; and
performing inverse short-time Fourier transformation on the time-frequency domain enhanced signal to obtain the target audio signal.

4. The method according to claim 2, wherein the collecting the original air conduction signal from the air conduction microphone comprises:
collecting a plurality of original air conduction signals from different directions from a plurality of air conduction microphones.

5. The method according to claim 4, wherein the plurality of air conduction microphones comprise a single-directional air conduction microphone and an all-directional air conduction microphone, and the collecting the plurality of original air conduction signals comprises:
determining a target direction where audio signals are greater than a preset decibel threshold, and directionally collecting an audio signal in the target direction from the single-directional air conduction microphone to obtain a single-directional original air conduction signal; and
collecting audio signals in all directions from the all-directional air conduction microphone to obtain all-directional original air conduction signals.

6. The method according to claim 5, wherein the performing short-time Fourier transformation on the original air conduction signal to obtain a frequency domain signal of the original air conduction signal, and the acquiring the air conduction audio signal based on the original air conduction signal and the frequency domain signal of the original air conduction signal comprises:
performing short-time Fourier transformation on a plurality of original air conduction signals to obtain frequency domain signals of the plurality of original air conduction signals, and obtaining a plurality of air conduction audio signals based on the plurality of original air conduction signals and the corresponding frequency domain signals, wherein the plurality of air conduction audio signals comprise a single-directional air conduction audio signal transformed from the single-directional original air conduction signal; and wherein the method further comprises:
multiplying the predicted amplitude by a phase of the single-directional air conduction audio signal.

7. The method according to claim 1, wherein before the inputting the voiceprint feature of the bone conduction audio signal, the first audio feature, and the second audio feature into the amplitude prediction model to obtain the predicted amplitude, the method further comprises:
acquiring an air conduction audio signal sample and a bone conduction audio signal sample;
acquiring a third audio feature of the air conduction audio signal sample and a fourth audio feature of the bone conduction audio signal sample; and
using the bone conduction audio signal sample as input data for the feature extraction model, using output of the feature extraction model, the third audio feature, and the fourth audio feature as input data for the amplitude prediction model, and using an amplitude of the air conduction audio signal sample as target output of the amplitude prediction model, to perform fusion training on the feature extraction model and the amplitude prediction model.

8. The method according to claim 7, wherein the acquiring the air conduction audio signal sample and the bone conduction audio signal sample comprises:
collecting an original air conduction signal sample based on the air conduction microphone, and collecting an original bone conduction signal sample based on the bone conduction microphone, wherein:
the air conduction microphone comprise a single-directional air conduction microphone and an all-directional air conduction microphone,
a single-directional original air conduction signal sample is directionally collected based on the single-directional air conduction microphone, and
an all-directional original air conduction signal sample is collected based on the all-directional air conduction microphone;
performing short-time Fourier transformation on the original air conduction signal sample to obtain a frequency domain signal sample of the original air conduction signal sample, and obtaining the air conduction audio signal sample based on the original air conduction signal sample and the frequency domain signal sample of the original air conduction signal sample; and
performing short-time Fourier transformation on the original bone conduction signal sample to obtain a frequency domain signal sample of the original bone conduction signal sample, and obtaining the bone conduction audio signal sample based on the original bone conduction signal sample and the frequency domain signal sample of the original bone conduction signal sample.

9. An audio enhancement apparatus, comprising:
one or more processors; and
memory storing instructions that, when executed by the one or more processors, cause the audio enhancement apparatus to:
acquire an air conduction audio signal from an air conduction microphone and a bone conduction audio signal from a bone conduction microphone;
determine a first audio feature of the air conduction audio signal and a second audio feature of the bone conduction audio signal;
perform feature extraction on the bone conduction audio signal using a feature extraction model to obtain a voiceprint feature of the bone conduction audio signal;
input the voiceprint feature of the bone conduction audio signal, the first audio feature, and the second audio feature into an amplitude prediction model to obtain a predicted amplitude; and
obtain a target audio signal based on the predicted amplitude.

10. The audio enhancement apparatus according to claim 9, wherein the instructions, when executed by the one or more processors, cause the audio enhancement apparatus to acquire the air conduction audio signal and the bone conduction audio signal by:
collecting an original air conduction signal from the air conduction microphone, and collecting an original bone conduction signal from the bone conduction microphone;
performing short-time Fourier transformation on the original air conduction signal to obtain a frequency domain signal of the original air conduction signal;
acquiring, based on the original air conduction signal and the frequency domain signal of the original air conduction signal, the air conduction audio signal;
performing short-time Fourier transformation on the original bone conduction signal to obtain a frequency domain signal of the original bone conduction signal; and
acquiring, based on the original bone conduction signal and the frequency domain signal of the original bone conduction signal, the bone conduction audio signal.

11. The audio enhancement apparatus according to claim 9, wherein the instructions, when executed by the one or more processors, cause the audio enhancement apparatus to obtain the target audio signal based on the predicted amplitude by:
multiplying the predicted amplitude by a phase of the air conduction audio signal to obtain a multiplication result as a time-frequency domain enhanced signal; and
performing inverse short-time Fourier transformation on the time-frequency domain enhanced signal to obtain the target audio signal.

12. The audio enhancement apparatus according to claim 10, wherein the instructions, when executed by the one or more processors, cause the audio enhancement apparatus to collect the original air conduction signal from the air conduction microphone by:
collecting a plurality of original air conduction signals from different directions from a plurality of air conduction microphones.

13. The audio enhancement apparatus according to claim 12, wherein the plurality of air conduction microphones comprise a single-directional air conduction microphone and an all-directional air conduction microphone, and wherein the instructions, when executed by the one or more processors, cause the audio enhancement apparatus to collect the plurality of original air conduction signals by:
determining a target direction where audio signals are greater than a preset decibel threshold, and directionally collecting an audio signal in the target direction from the single-directional air conduction microphone to obtain a single-directional original air conduction signal; and
collecting audio signals in all directions from the all-directional air conduction microphone to obtain all-directional original air conduction signals.

14. The audio enhancement apparatus according to claim 13, wherein the instructions, when executed by the one or more processors, cause the audio enhancement apparatus to perform short-time Fourier transformation on the original air conduction signal to obtain a frequency domain signal of the original air conduction signal, and acquire the air conduction audio signal based on the original air conduction signal and the frequency domain signal of the original air conduction signal by:
performing short-time Fourier transformation on a plurality of original air conduction signals to obtain frequency domain signals of the plurality of original air conduction signals, and obtaining a plurality of air conduction audio signals based on the plurality of original air conduction signals and the corresponding frequency domain signals, wherein the plurality of air conduction audio signals comprise a single-directional air conduction audio signal transformed from the single-directional original air conduction signal; and
wherein the instructions, when executed by the one or more processors, further cause the audio enhancement apparatus to:
multiply the predicted amplitude by a phase of the single-directional air conduction audio signal.

15. The audio enhancement apparatus according to claim 9, wherein before inputting the voiceprint feature of the bone conduction audio signal, the first audio feature, and the second audio feature into the amplitude prediction model to obtain the predicted amplitude, the instructions, when executed by the one or more processors, cause the audio enhancement apparatus to:
acquire an air conduction audio signal sample and a bone conduction audio signal sample;
acquire a third audio feature of the air conduction audio signal sample and a fourth audio feature of the bone conduction audio signal sample; and
use the bone conduction audio signal sample as input data for the feature extraction model, using output of the feature extraction model, the third audio feature, and the fourth audio feature as input data for the amplitude prediction model, and use an amplitude of the air conduction audio signal sample as target output of the amplitude prediction model, to perform fusion training on the feature extraction model and the amplitude prediction model.

16. The audio enhancement apparatus according to claim 15, wherein the instructions, when executed by the one or more processors, cause the audio enhancement apparatus to acquire the air conduction audio signal sample and the bone conduction audio signal sample by:
collecting an original air conduction signal sample based on the air conduction microphone, and collecting an original bone conduction signal sample based on the bone conduction microphone, wherein:
the air conduction microphone comprise a single-directional air conduction microphone and an all-directional air conduction microphone,
a single-directional original air conduction signal sample is directionally collected based on the single-directional air conduction microphone, and
an all-directional original air conduction signal sample is collected based on the all-directional air conduction microphone;
performing short-time Fourier transformation on the original air conduction signal sample to obtain a frequency domain signal sample of the original air conduction signal sample, and obtaining the air conduction audio signal sample based on the original air conduction signal sample and the frequency domain signal sample of the original air conduction signal sample; and
performing short-time Fourier transformation on the original bone conduction signal sample to obtain a frequency domain signal sample of the original bone conduction signal sample, and obtaining the bone conduction audio signal sample based on the original bone conduction signal sample and the frequency domain signal sample of the original bone conduction signal sample.

17. An earphone system comprising:
an air conduction microphone configured to acquire an air conduction audio signal;
a bone conduction microphone configured to acquire a bone conduction audio signal;
one or more processors; and
memory storing instructions that, when executed by the one or more processors, cause the earphone system to:
receive the air conduction audio signal and the bone conduction audio signal;
determine a first audio feature of the air conduction audio signal and a second audio feature of the bone conduction audio signal;
perform feature extraction on the bone conduction audio signal using a feature extraction model to obtain a voiceprint feature of the bone conduction audio signal;
input the voiceprint feature of the bone conduction audio signal, the first audio feature, and the second audio feature into an amplitude prediction model to obtain a predicted amplitude; and
obtain a target audio signal based on the predicted amplitude.

18. The earphone system according to claim 17, wherein the instructions, when executed by the one or more processors, cause the earphone system to obtain the target audio signal based on the predicted amplitude by:
multiplying the predicted amplitude by a phase of the air conduction audio signal to obtain a multiplication result as a time-frequency domain enhanced signal; and
performing inverse short-time Fourier transformation on the time-frequency domain enhanced signal to obtain the target audio signal.

19. The earphone system according to claim 18, further comprising a plurality of air conduction microphones, wherein the instructions, when executed by the one or more processors, cause the earphone system to collect the original air conduction signal from the air conduction microphone by:
collecting a plurality of original air conduction signals from different directions from the plurality of air conduction microphones.

20. The earphone system according to claim 17, wherein the air conduction microphone comprises a single-directional air conduction microphone and an all-directional air conduction microphone.
